(19) United States
(12) Patent Application Publication
(10) Pub. No.: US 2015/0081809 A1
(43) Pub. Date: Mar. 19, 2015

(54) CONTROLLING DELIVERY AND ACCESS OF ELECTRONIC COMMUNICATIONS

(71) Applicant: International Business Machines Corporation, Armonk, NY (US)

(72) Inventors: Ashish Mungi, Bangalore (IN); Ram Viswanathan, Chennai, TN (US)

(73) Assignee: International Business Machines Corporation, Armonk, NY (US)

(21) Appl. No.: 14/030,125

(22) Filed: Sep. 18, 2013

(51) Int. Cl. H04L 12/58

(52) U.S. Cl. CPC H04L 51/04
USPC 709/206

(57) ABSTRACT

A method, system and a computer program product of a computer controlling delivery and access of electronic communications is provided which includes providing an electronic communication sender to include a security measure with respect to an electronic communication to be sent to at least one electronic communication account of at least one intended recipient, receiving and applying the electronic communication security measure to the electronic communication to be sent, sending the electronic communication with the security measure to at least one intended recipient, determining existence of one or more delegates of the electronic communication account of the at least one intended recipient and in response to the determination step, preventing the sent electronic communication with the security measure from view by the one or more delegate of the electronic communication account of the at least one intended recipient.

### TECHNICAL FIELD

The present invention relates to controlling delivery and access of electronic communications. More specifically, the present invention relates to controlling delivery and access of emails to delegates of the email recipient and sender.

### BACKGROUND OF THE INVENTION

Most of the email applications available today provide a facility to the users to delegate access thereto to multiple other delegated users. For example, an assistant or secretary to a Senior Executive may be provided delegated access to the email application of the Senior Executive. In such a situation, the delegates can send/receive emails from the user's email application and will typically have access to every email in the user's email application. However, the user (sender or recipient of email) may wish to restrict the delegates' access to particular emails that may contain sensitive or highly classified information (e.g., payroll information). Although, the current email applications provide the ability to restrict the access of the emails from the delegates, it is now only possible after the user has received/sent the email. Also, current email applications do not allow an email sender to restrict access to delegates of the email recipients. In the time between receiving/sending the email and marking it as private by the user to prevent access thereof to the delegates, it is possible the delegates may access the received/sent email. Thus, it is desirable to restrict access of an email from the delegates (of the sender and receiver user) at the source of generation of the email i.e. before sending the email.

### SUMMARY

A method, system and a computer program product of a computer controlling delivery and access of electronic communications is provided which includes providing an electronic communication sender to include a security measure with respect to an electronic communication to be sent to at least one electronic communication account of at least one intended recipient, receiving and applying the electronic communication security measure to the electronic communication to be sent, sending the electronic communication with the security measure to at least one intended recipient, determining existence of one or more delegates of the electronic communication account of the at least one intended recipient and in response to the determination step, preventing the sent electronic communication with the security measure from view by the one or more delegate of the electronic communication account of the at least one intended recipient.

According to an embodiment, the sent electronic communication with security measure is delivered into a pre-designated folder of the electronic communication account of the at least one intended recipient. Further, the security measure may be removed from the electronic communication of the at least one intended recipient and in response to the removal step, at least one of the following steps may be selected and performed: moving the electronic communication with the removed security measure from the pre-designated folder to an inbox folder of the electronic communication account of the at least one intended recipient and making the electronic communication with removed security measure viewable to the delegates of the electronic communication account of the at least one intended recipient.

According to an embodiment, existence of delegates of an electronic communication account of the electronic communication sender is determined and in response the determination, the sent electronic communication with the security measure is prevented from view by the delegates of the electronic communication sender. The sent electronic communication with security measure is stored in a pre-designated folder of the electronic communication account of the electronic communication sender. Further, the security measure from the electronic communication of the electronic communication sender may be removed and in response to the removal step, at least one of the following steps may be selected and performed: moving the sent electronic communication with the removed security measure from the pre-designated folder to a sent items folder of the electronic communication account of the electronic communication sender and providing access of the sent electronic communication with the removed security measure to the delegates of the electronic communication account of the electronic communication sender.

### BRIEF DESCRIPTION OF THE DRAWINGS

FIG. 1 illustrates a block diagram of a computing system for implementing embodiments of the present invention.

FIG. 2 illustrates a block diagram of a system for implementing embodiments of the present invention.

FIG. 3 depicts a snap shot of an electronic communication application to perform an embodiment of the present invention.

FIG. 4 illustrates a flowchart depicting steps to be performed for implementing an embodiment of the present invention.

FIG. 5 illustrates a flowchart depicting steps to be performed for implementing another embodiment of the present invention.

### DETAILED DESCRIPTION

As will be appreciated by one skilled in the art, embodiments of the present invention may be embodied as a system, method or computer program product. Accordingly, embodiments of the present invention may take the form of an entirely hardware embodiment, an entirely software embodiment (including firmware, resident software, micro-code, etc.) or an embodiment combining software and hardware embodiments that may all generally be referred to herein as a “circuit,” “module” or “system.” Furthermore, embodiments of the present invention may take the form of a computer program product, embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

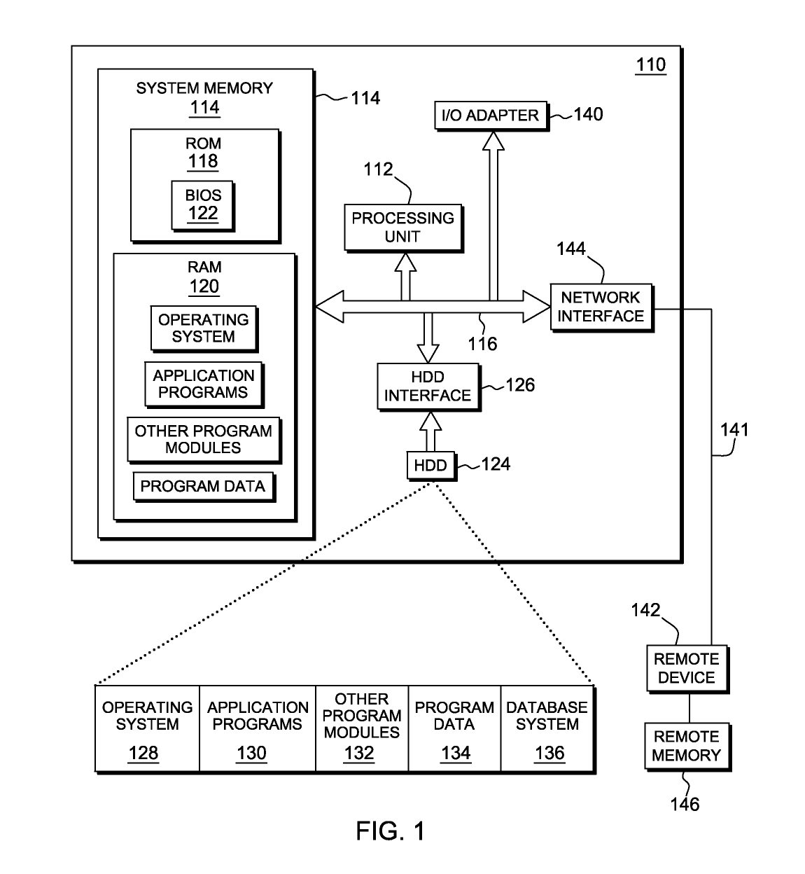

FIG. 1 illustrates a block diagram of a computing system for implementing an embodiment of the present invention. The computing system includes a computing device 110, which in turn includes a processing unit 112, a system memory 114, and a system bus 116 that couples various system components including the system memory 114 to the processing unit 112. The system bus 116 may be any of several types of bus architectures, including a memory bus, a memory controller, a peripheral bus, and a local bus using any of a variety of bus architectures, such as PCI. The system memory 114 can include a Read Only Memory (ROM) 118 and a Random Access Memory (RAM) 120. A Basic Input/Output System (BIOS) 122, containing the basic routines that help to transfer information between elements within the computing device 110, such as during start-up, is stored in the ROM 118. The computing device 110 further includes a Hard Disk Drive (HDD) 124 as computer-readable storage media. The HDD 124 is connected to the system bus 116 by an HDD interface 126. The HDD 124 provides a non-volatile storage for computer-readable instructions, data structures, program modules, and other data for the computing device 110. Although the exemplary environment described herein employs the HDD 124, it should be appreciated by those skilled in the art that other types of computer-readable storage media, which can store data that is accessible by computer, such as RAM, ROM, removable magnetic disks, removable optical disks, and the like may also be used in the exemplary operating environment.

A number of program modules may be stored on the HDD 124, including an operating system 128, one or more application programs 130, other program modules 132, program data 134, and a database system 136. The operating system 128, the one or more application programs 130, the other program modules 132 and program data 134 may be loaded onto the system memory 114 and specifically onto the RAM 120 during the functioning of the computing device 110. A user may provide commands and information through input devices, such as a keyboard, and receive output through peripheral output devices, such as monitor, speaker, printer, etc. (not shown). These input and output devices are often connected to the processing unit 112 through an I/O adapter 140 coupled to the system bus 116.

In a networked environment, the computing device 110 may be connected to a remote computing device 142 through a network interface card 144. It will be appreciated that the network connections shown are exemplary, and any conventional means 141 of establishing communications links between the computers, such as a local area network, wide are network or wireless connection, may be used. In a networked environment, program modules depicted relative to the computing device 110, or its components, may be stored in a remote memory 146. The remote computing device 142 may be a personal computer, a router, a server, a network PC, a peer device, or other common network device.

Those of the ordinary skill in the art will appreciate that the hardware in FIG. 1 is a basic computing system and may vary. The architecture of the aforementioned computing device is not limiting and is only depicted as an example on which an embodiment of the present invention may be implemented. Other types of computing system such as a smart phone or a web-kiosk are well within the intended scope on which an embodiment of the present invention may be implemented.

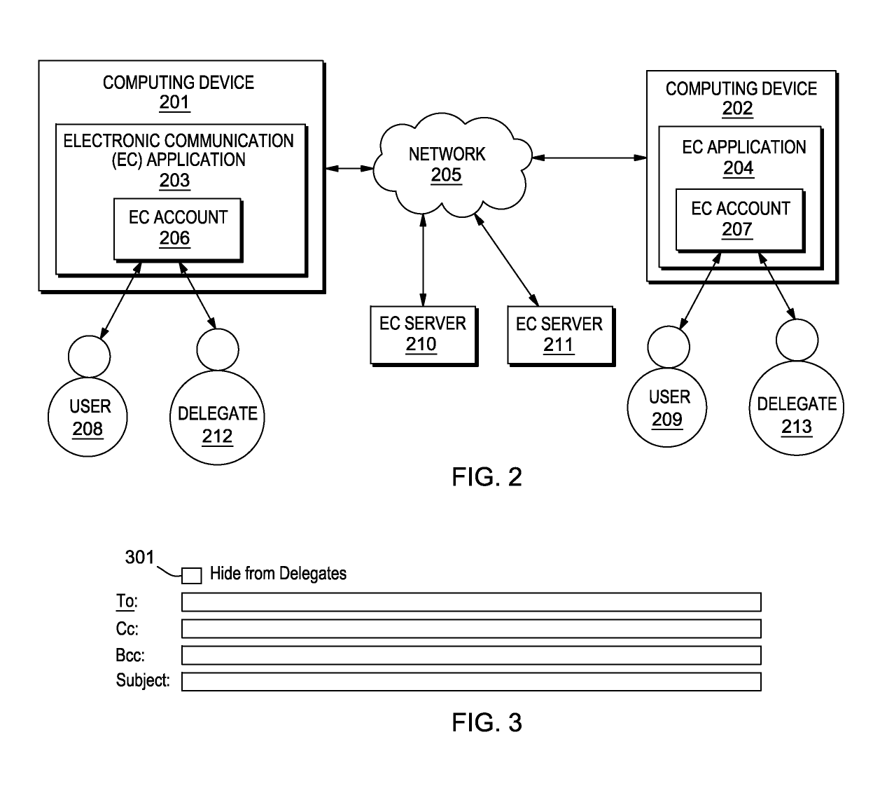

FIG. 2 illustrates a block diagram of a system for implementing an embodiment of the present invention. A computing device (201, 202) such as the one illustrated in FIG. 1 hosts an electronic communication application (203, 204) for sending and receiving electronic communications such as electronic mail (email). Alternatively, the electronic communication application (203, 204) may be web based and accessible through a network 205 such as internet through an internet browser operable from a computing device (201, 202) as illustrated in FIG. 1. The electronic communication application (203, 204) is configured to manage one or more electronic communication accounts (206, 207). An electronic communication account (such as abcd@abcd.com) 206 is unique to and operated by a user 208 (through user credentials such as username and password) to send and receive electronic communications from users 209 of other electronic communication account 207 managed by their respective electronic communication applications (203, 204) hosted on respective computing devices (201, 202) as illustrated in FIG. 1. The outgoing and incoming electronic communications from the electronic communication accounts (206, 207) are routed through their respective electronic communication servers (210, 211) communicatively connected to the electronic communication accounts (206, 207) through the respective electronic communication applications (203, 204). An electronic communication sent from an electronic communication account 206 is transmitted to an electronic communication server 210 in communication therewith. The electronic communication server 210 associated with the sender electronic communication account 206 transmits the electronic communication to the electronic communication server 211 associated with the receiver electronic communication account 207 which in turn delivers the received electronic communication to the recipient electronic communication account 207 in communication therewith. It is possible that a single electronic communication server is communication with multiple electronic communication accounts.

The electronic communication applications (203, 204), accounts (206, 207) and servers (210, 211) are typically hosted on computing devices (201, 202) as illustrated in FIG. 1 with their respective underlying software which is a common art in today's world and readily known to a person skilled in the art. Typical examples of electronic communication application include Microsoft Outlook provided by Microsoft Inc., Lotus Notes provided by IBM, etc. The electronic communication accounts (206, 207) and respective servers (210, 211) communicate with each other through the network 205 such as an internet network. The methodologies of such communication is also a very well known art and readily known to a person skilled in the art.

Generally, an electronic communication application (203, 204) allows delegation of rights by the user (208, 209) of the electronic communication account (206, 207) to other users i.e. delegates (212, 213) for example the user's Assistant or Secretary, for sending and receiving electronic communications on their behalf. In such a scenario, the delegates can possibly have access to all incoming/outgoing electronic communications of the electronic communication account of the user. The level of access to the delegates (212, 213) is determined by the user (208, 209).

According to an embodiment of the present subject matter, there is provided a feature in the electronic communication applications (203, 204) to include a security measure in respect of an electronic communication to be sent by the user 208 of the electronic communication account 203 managed by the respective electronic communication application 203 to electronic communication account 207 of the intended recipient 209. The user or sender 208 may select a check box 301, as shown in FIG. 3, in the electronic communication application 203 to include the security measure in respect of an electronic communication to be sent to one or more electronic communication accounts 207 of the intended recipients 209. It is obvious that there may be provided other means to select and include the security measure in an electronic communication to be sent. The security measure is included to ensure that the sent electronic communication is delivered only to the electronic communication account 207 of the intended recipient and not to the delegate 213. The electronic communication application 203 receives and applies the security measure to the electronic communication to be sent. Alternatively, the application of the security measure to the electronic communication to be sent may be applied by the electronic communication server 210 associated with the sender's electronic communication account. The configuration of the electronic communication application 203, account 206 and server 210 to provide, receive and apply the aforementioned security measure may be done including appropriate software codes or modules therein. Preparing and including appropriate software codes or modules to enhance the functionality of a software application is a known skilled in the art.

The electronic communication with security measure is now sent by the electronic communication account 206 to the electronic communication server 210 associated therewith. The electronic communication server 210 associated with the sender electronic communication account 206 transmits thereof to the electronic communication server 211 associated with the electronic communication account 207 of the intended recipient 209. The electronic communication server 211 associated with the electronic communication account 207 of the intended recipient 209 is configured to detect a presence of the security measure within the received electronic communication by it. This triggers a determination of existence of delegate(s) 213 of the electronic communication account 207 of the intended recipient 209. If it is determined that the delegate(s) 213 exist or are defined, the viewing of the sent electronic communication with the security measure is not allowed by the delegate(s) 213. Thus, the sent electronic communication with the security measure is made viewable only to the intended recipient 209 and not its delegate 213. Alternatively, the aforementioned processes of the detecting the received electronic communication with the security measure, determining existence of delegate(s) 213 of the electronic communication account 207 of the intended recipient 209 and preventing view of the received electronic communication with the security measure from the delegate 213 of the electronic communication account 207 of the intended recipient 209 may be performed by the electronic communication application 204. The configuration of the electronic communication server 211 or application 204 at the intended recipient's 209 end to detect a received electronic communication with the security measure and further preventing it from view by the delegate 213 of the electronic communication account 204 of the intended recipient 209 may be done by including appropriate software codes or modules therein. Preparing and including appropriate software codes or modules to enhance the functionality of a software application is a known skilled in the art.

According to an embodiment, the sent electronic communication with security measure is delivered into a pre-designated folder of the electronic communication account 207 of the intended recipient 209. The electronic communication application 204 may be configured to deliver an incoming electronic communication satisfying pre-defined rules directly into a pre-designated folder instead of a generally default ‘inbox’ folder. Thus, if an incoming electronic communication is detected to comprise a security measure as described above, it may be delivered directly into the pre-designated folder (not shown) of the electronic communication account 207 of the intended recipient 209 bypassing the generally default ‘inbox’ folder (not shown).

According to an embodiment, the electronic communication with the security measure received by the intended recipient 209 may comprise an identifier indicating it comprises the security measure which prevents it from view to the delegate 213 of the intended recipient 209.

According to an embodiment, the intended recipient 209 may be provided with capability to remove the security measure from the received electronic communication with the security measure. The removal may be effected by toggling or removing the aforementioned indicator. Upon the aforementioned removal, the electronic communication with the removed security measure is moved from the pre-designated folder to a default ‘inbox’ folder of the electronic communication account 207 of the intended recipient 209 as well as making thereof viewable by the delegate 213 of the electronic communication account 207 of the intended recipient 209. The configuration of the electronic communication application 204 to provide capability to remove the indicator to remove the security measure from the received electronic communication with the security measure, and moving the electronic communication to the default inbox folder thereby making it viewable by the delegate 209 may be made available by including appropriate software codes or modules therein. Preparing and including appropriate software codes or modules to enhance the functionality of a software application is a known to one skilled in the art.

According to an embodiment, the electronic communication server associated with the sender electronic communication account 206, determines existence of delegate(s) 212 of the sender's 208 electronic communication account 206. If it is determined that the delegate(s) 212 exist or are defined, the sent electronic communication with the security measure is prevented from view by the delegate 212 of the sender's 208 electronic communication account 206. Thus, the sent electronic communication with the security measure is made viewable only to the sender 208 of the electronic communication with the security measure. Alternatively, the aforementioned processes of the determining existence of delegate(s) 212 of the sender's 208 electronic communication account 206 and preventing view of the sent electronic communication with the security measure by the delegate 212 of the sender's 208 electronic communication account 206 may be performed by the respective electronic communication application 203. The appropriate configuration of the electronic communication server 210 or application 203 may be done by including appropriate software codes or modules therein. Preparing and including appropriate software codes or modules to enhance the functionality of a software application is a known skilled in the art.

According to an embodiment, the sent electronic communication with security measure is delivered into a pre-designated folder of the sender's 208 electronic communication account 206. The electronic communication application 206 may be configured to deliver an outgoing electronic communication satisfying pre-defined rules directly into a pre-designated folder instead of the generally default ‘sent items’ folder. Thus, if an outgoing electronic communication is detected to comprise a security measure as described above, it may be delivered directly into the pre-designated folder of the sender's 208 electronic communication account 206 bypassing the generally default ‘sent items’ folder.

According to an embodiment, the sent electronic communication with the security measure may comprise an identifier to identify the sender of the sent electronic communication with the security measure.

According to an embodiment, the sender 208 of sent electronic communication with the security measure may be provided capability to remove the security measure from the electronic communication. The removal may be effected by toggling or removing the aforementioned indicator. Along with the aforementioned removal, the electronic communication with the removed security measure is moved from the pre-designated folder to a default ‘sent items’ folder of the sender's 208 electronic communication account 206 as well as making it viewable by the delegate 212 of the sender's 208 electronic communication account 206. The configuration of the electronic communication application 203 to provide capability to remove the indicator to remove the security measure from a sent electronic communication with the security measure, and moving thereof to the default ‘sent items’ folder thereby making it viewable by the designates of the sender's electronic communication may be made available by including appropriate software codes or modules therein. Preparing and including appropriate software codes or modules to enhance the functionality of a software application is a known skilled in the art.

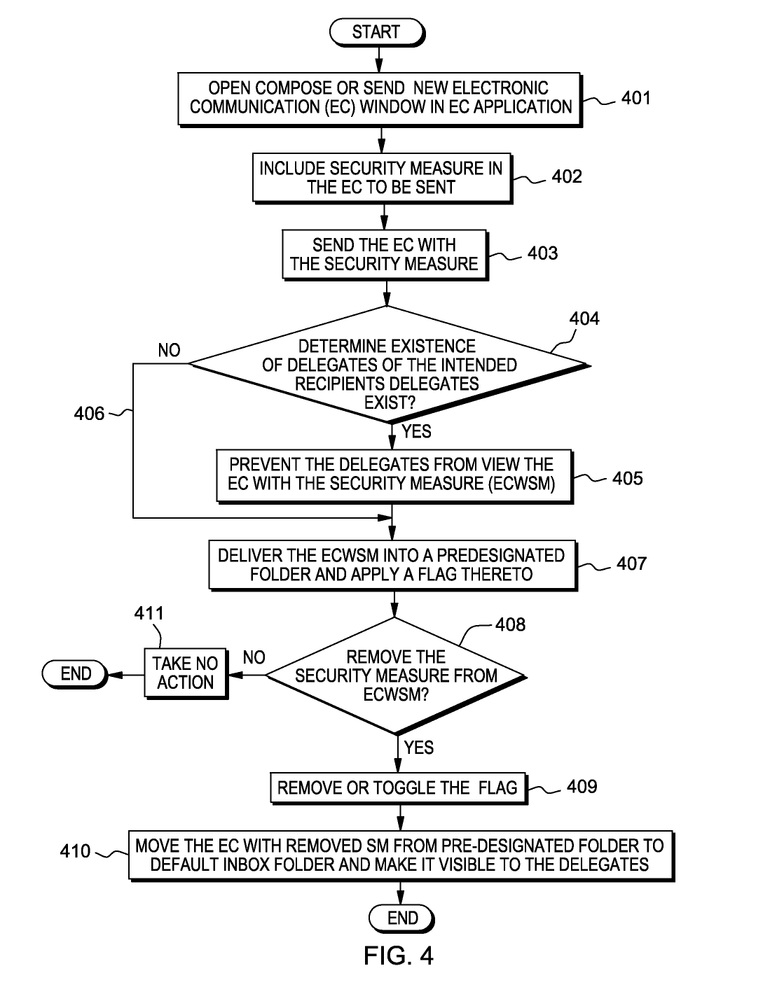

FIG. 4 illustrates flowcharts depicting steps to be performed for implementing an embodiment of the present invention by a computer controlling delivery and access of electronic communications. At steps 401, a user of an electronic communication application opens a ‘compose or send new electronic communication’ window to send an electronic communication to an electronic communication account of at least one intended recipient. For the rest of the description, the user of the electronic communication at step 401 sending the electronic communication shall be referred to as sender. At step 402, the sender is provided to include a security measure in respect of the electronic communication to be sent. The security measure is included to ensure that the sent electronic communication is delivered only to the electronic communication account of the intended recipients and not to the delegates of the intended recipients the electronic communication accounts. Generally, the electronic communication applications allow delegation of rights by the user of the electronic communication account to other users i.e. delegates, for example the user's Assistant or Secretary, for sending and receiving electronic communications on their behalf. In such a scenario, the delegates can possibly have access to all incoming/outgoing electronic communications of the electronic communication account of the user. The level of access to the delegates is determined by the user.

At step 403, the electronic communication with the security measure is sent to at least one electronic communication account of the at least one intended recipient.

At step 404, before delivering the sent electronic communication with security measure to the electronic communication account of the intended recipients the computer determines existence of delegates of the electronic communication accounts of the intended recipients. At step 405 (yes branch of step 404), if the delegates exist or are defined, the sent electronic communication with the security measure is prevented from view by the delegates. Thus, the sent electronic communication with the security measure is made viewable only to the intended recipients and not its delegates. At step 406 (no branch of step 404), if no delegates exist, the method proceeds to step 407 as described below.

At step 407, the sent electronic communication with security measure is delivered into a pre-designated folder of the electronic communication accounts of the intended recipients instead of a generally default ‘inbox’ folder. Also, an indicator is applied to the electronic communication with the security measure received by the intended recipients to identify that it includes a security measure which prevents it from view by the delegates of the electronic communication account of the intended recipients.

At step 408, the intended recipient may remove the security measure from the received electronic communication with the security measure. If yes, at step 409, the removal may be effected by toggling or removing the aforementioned indicator. At step 410, (yes branch of step 408) the aforementioned indicator is toggled or removed to remove the security measure from the received electronic communication with the security measure, the electronic communication with the removed security measure is moved from the pre-designated folder to a default ‘inbox’ folder of the electronic communication account of the intended recipient as well as making it viewable by the designates of the electronic communication account of the intended recipients. If the intended recipient wants to retain the security measure in the received electronic communication, at step 411, no action is taken (no branch of step 408).

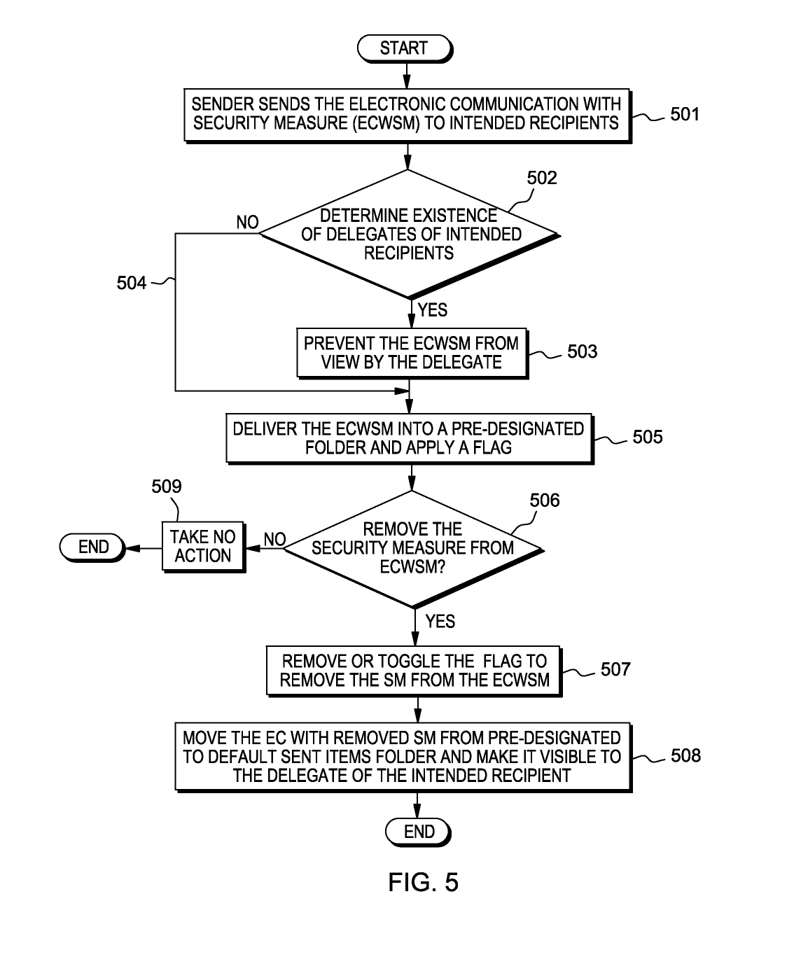

In addition to the aforementioned steps, the following steps may be performed to prevent view of the sent electronic communication with the security measure from the delegates of the sender's electronic communication account. FIG. 5 illustrates a flowchart depicting these steps to be performed according to an embodiment of the present invention. At step 501, the sender sends the electronic communication with the security measure to at least one intended recipients. At step 502, existence of delegates of the sender's electronic communication account is determined. At step 503, if it is determined that the delegates exist or are defined, the sent electronic communication with the security measure is prevented from view by the delegates of the sender's electronic communication account. Thus, the sent electronic communication with the security measure is made viewable only to the sender of the electronic communication with the security measure. At step 504, if no delegates exist, step 505 as described below is performed.

At step 505, the sent electronic communication with security measure is delivered into a pre-designated folder of the sender's electronic communication account instead of the generally default ‘sent items’ folder. Also, an indicator is applied to the sent electronic communication with the security measure to identify it includes a security measure preventing it from view by the delegates of the sender's electronic communication account.

At step 506, the sender of the sent electronic communication with the security measure may remove the security measure therefrom. If yes, at step 507, the removal may be effected by toggling or removing the aforementioned indicator. At step 508, the electronic communication with the removed security measure is moved from the pre-designated folder to a default ‘sent items’ folder of the sender's electronic communication account as well as making it viewable by the delegates of the sender's electronic communication account. If the sender wants to retain the security measure in the received electronic communication, at step 509, no action is taken.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of a computer controlling delivery and access of electronic communications, the method comprising the steps of:
providing an electronic communication sender to include a security measure with respect to an electronic communication to be sent to at least one electronic communication account of at least one intended recipient;
receiving and applying the electronic communication security measure to the electronic communication to be sent;
sending the electronic communication with the security measure to at least one intended recipient;
determining existence of one or more delegates of the electronic communication account of the at least one intended recipient; and
in response to the determining step,
preventing the sent electronic communication with the security measure from view by the one or more delegate of the electronic communication account of the at least one intended recipient.

2. The method of claim 1, wherein the sent electronic communication with security measure is delivered into a pre-designated folder of the electronic communication account of the at least one intended recipient.

3. The method of claim 2 further includes
removing the security measure from the electronic communication of the at least one intended recipient; and
in response to the removal step, selecting and performing at least one of the following steps:
moving the electronic communication with the removed security measure from the pre-designated folder to an inbox folder of the electronic communication account of the at least one intended recipient;
making the electronic communication with removed security measure viewable to the delegates of the electronic communication account of the at least one intended recipient.

4. The method of claim 1 further includes:
determining existence of delegates of an electronic communication account of the electronic communication sender; and
in response to the determining step,
preventing the sent electronic communication from view by the delegates of the electronic communication account of the electronic communication sender.

5. The method of claim 4, wherein the sent electronic communication with security measure is stored in a pre-designated folder of the electronic communication account of the electronic communication sender.

6. The method of claim 5 further includes:
removing the security measure from the electronic communication of the electronic communication sender; and
in response to the removal step, selecting and performing at least one of the following steps:
moving the sent electronic communication with the removed security measure from the pre-designated folder to a sent items folder of the electronic communication account of the electronic communication sender; and
providing access of the sent electronic communication with the removed security measure to the delegates of the electronic communication account of the electronic communication sender.

7. A system implemented in a hardware for controlling delivery and of electronic communications, the system comprising a computer infrastructure operable to:
provide an electronic communication sender to include a security measure with respect to an electronic communication to be sent to at least one electronic communication account of at least one intended recipient;
receive and apply the electronic communication security measure to the electronic communication to be sent;
send the electronic communication with the security measure to at least one intended recipient;
determine existence of one or more delegates of the electronic communication account of the at least one intended recipient; and
in response to the determining step,
prevent the sent electronic communication with the security measure from view by the one or more delegate of the electronic communication account of the at least one intended recipient.

8. The system of claim 7, wherein computer infrastructure is operable to deliver the sent electronic communication with security measure into a pre-designated folder of the electronic communication accounts of the at least one intended recipient.

9. The system of claim 8, wherein the computer infrastructure is operable to:
remove the security measure from the electronic communication of the at least one intended recipient; and
in response to the removal step, selecting and performing at least one of the following steps:
move the electronic communication with the removed security measure from the pre-designated folder to an inbox folder of the electronic communication account of the at least one intended recipient;
make the electronic communication with removed security measure viewable to the delegates of the electronic communication account of the at least one intended recipient.

10. The system of claim 7, wherein the computer infrastructure is further operable to:
determine existence of delegates of an electronic communication account of the electronic communication sender; and
in response to the determining step,
prevent the sent electronic communication from view by the delegates of the electronic communication account of the electronic communication sender.

11. The system of claim 10, wherein the sent electronic communication with security measure is stored in a pre-designated folder of the electronic communication account of the electronic communication sender.

12. The system of claim 11, wherein the computer infrastructure is further operable to:
remove the security measure from the electronic communication of the electronic communication sender; and
in response to the removal step, select and performing at least one of the following steps:
move the sent electronic communication with the removed security measure from the pre-designated folder to a sent items folder of the electronic communication account of the electronic communication sender; and
provide access of the sent electronic communication with the removed security measure to the delegates of the electronic communication account of the electronic communication sender.

13. A computer program product comprising a computer usable storage medium having readable program code embodied in the storage medium, the computer program product comprises at least one component operable to:
provide an electronic communication sender to include a security measure with respect to an electronic communication to be sent to at least one electronic communication account of at least one intended recipient;
receive and apply the electronic communication security measure to the electronic communication to be sent;
send the electronic communication with the security measure to at least one intended recipient;
determine existence of one or more delegates of the electronic communication account of the at least one intended recipient; and
in response to the determining step,
prevent the sent electronic communication with the security measure from view by the one or more delegates of the electronic communication account of the at least one intended recipient.

14. The computer program product of claim 13, wherein at least one component of the computer program product is operable to deliver the sent electronic communication with security measure into a pre-designated folder of the electronic communication accounts of the at least one intended recipient.

15. The computer program product of claim 14, wherein at least one component of the computer program product is operable to:
remove the security measure from the electronic communication of the at least one intended recipient; and
in response to the removal step, selecting and performing at least one of the following steps:
move the electronic communication with the removed security measure from the pre-designated folder to an inbox folder of the electronic communication account of the at least one intended recipient; and
make the electronic communication with removed security measure viewable to the delegates of the electronic communication account of the at least one intended recipient.

16. The computer program product of claim 13, wherein at least one component of the computer program product is further operable to:
determine existence of delegates of an electronic communication account of the electronic communication sender; and
in response to the determining step,
prevent the sent electronic communication from view by the delegates of the electronic communication account of the electronic communication sender.

17. The computer program product of claim 16, wherein the sent electronic communication with security measure is stored in a pre-designated folder of the electronic communication account of the electronic communication sender.

18. The computer program product of claim 17, wherein at least one component of the computer program product is further operable to:
remove the security measure from the electronic communication of the electronic communication sender; and
in response to the removal step, select and performing at least one of the following steps:
move the sent electronic communication with the removed security measure from the pre-designated folder to a sent items folder of the electronic communication account of the electronic communication sender; and
provide access of the sent electronic communication with the removed security measure to the of the electronic communication account of the electronic communication sender.
